(19) United States
(12) Patent Application Publication
(10) Pub. No.: US 2009/0187954 A1
(43) Pub. Date: Jul. 23, 2009

(54) Button based video database interface

(76) Inventors: Andreas Tuerk, Steinebach (DE); Stephen Spence, Montain View, CA (US); Natalie Doduc, Mountain View, CA (US); Karen Groenink, Mountain View, CA (US); Matthew Sharifi, Mountain View, CA (US); Tim Jones, Mountain View, CA (US); Dwipal Desai, Mountain View, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/011,205

(22) Filed: Jan. 23, 2008

(51) Int. Cl. H04N 7/173

(52) U.S. Cl. 725/106

(57) ABSTRACT

The described embodiments of the present invention provide a video database client application configured to execute on a wireless communication device or a device with a small display screen. The video database client application includes a user interface including user interface components designed to access video information and view videos using the wireless communication device. The video database client application includes a video player module to integrate and control a native video player within the user interface. The video database client application further includes a video database interface module adapted to retrieve videos and video information from the video database. The video database interface module functions to pre-fetch information from the video database based on anticipated user information needs.

### BACKGROUND

1. Field

This invention relates to client software for wireless communication devices. Specifically, the invention relates to software that provides an interface for accessing and displaying information from a video database using a wireless communication device.

2. Background

Due to advancement in wireless communication device technology, wireless devices have become an increasingly prevalent substitute for personal computers. Wireless devices include, for example, cellular telephones, pagers, “palmtop” personal information managers (PIMS), and other small, primarily handheld communication and computing devices. Wireless communication devices have matured considerably in their features and are now used alternately with computers for more advanced communications functions, such as electronic mail, facsimile receipt and transmission, Internet access, browsing the World Wide Web, and the like.

In addition to communications related functions, wireless communications devices are also commonly used as personal entertainment devices in the same way the computers are currently used. Wireless devices are commonly used to play music, watch videos, play video games etc. However, wireless communication devices present a variety of more challenging design and implementation issues that do not arise with larger processor-based systems, such as notebook and desktop computers, which may also have similar telecommunication features. These design challenges include the design of the user interfaces and the integration of Internet and World Wide Web access with other communication functionality.

One constraint in the design of the user interfaces for wireless devices is the limited size of the display screen of the wireless device. Unlike desktop and notebook computers, wireless communication devices have a form factor that requires a very small screen display size. Desktop computers typically have displays with at least 14″ screen size, and resolution typically between 800×600 and 1280×1024 pixels. In contrast, wireless communication devices typically have a screen size between 25×25 mm and 80×120 mm, and resolutions between 176×144 to 240×320 pixels, or about 5% of the size of the desktop or notebook screen. As a direct result, the user interface design of the wireless communication device must provide access to essentially the same features as desktop computers, such as Web browsing, yet with only a fraction of the screen area for displaying text, images, icons, and the like. This problem of constructing the user interface to provide these features is particularly significant when handling Web-based content, since conventional Web content is frequently designed for presentation on the larger screen size of conventional desktop computers.

The severely restricted set of inputs available to user provides another constraint in the design of user interfaces for wireless communication devices. Conventional desktop or notebook computers have cursor-based pointing devices, such as a computer mouse, trackballs, joysticks, and the like, as well as a full-sized keyboard. This enables navigation of the Web content by clicking and dragging of scroll bars, clicking of hypertext links, and keyboard tabbing between fields of forms, such as HTML forms. In contrast, wireless communication devices have a very limited number of inputs, typically up and down keys, and one to three soft keys.

For websites that aim to provide the user with the ability to browse a large amount of information, such as video content distribution websites, the above constraints severely limit both the amount of information presented to the user and the ease with which the user can browse the information.

FIG. 1 illustrates a conventional video database interface designed for a mobile device. Due to limited screen space, only a subset of video information may be displayed at one time. The video information is displayed in a list format in order to facilitate user selection of videos using the up and down keys of the wireless communication device. In order to view additional or different video information, the user must select the next button. Upon this selection, the user must wait for the next set of video information to load onto the screen. Depending on the speed at which the wireless communication device can retrieve and process video information from the video database server, it may take several seconds to load the next set of video information.

At the bottom of the screen, a menu of the video database functions is listed in association with the different number keys. Navigation of the video database by highlighting and selecting the menu options or by using the number keys is cumbersome as the user is required to select from the entire menu of options. Further, the display of the entire menu of options takes up significant screen space and is difficult to read due to the large number of menu options displayed.

### SUMMARY

The described embodiments of the present invention provides a video database client application configured to execute on a wireless communication device or a device with a small display screen. The video database client application includes a user interface including user interface components designed to access video information and view videos using the wireless communication device. These user interface components include buttons to display menu options and account information to users. Other user interface components include a carousel display to interactively browse information associated with videos. These user-interface components facilitate browsing and navigation of the video database using the small screen display of the wireless communication device.

The video database client application includes a video player module to integrate and control a native video player within the user interface. The incorporation of a native video player within the interface facilitates user control of the video player. Control of the video player through the interface provided by the video database client application further enables the video database client application to monitor video viewing data and store this information in the video database.

The video database client application further includes a video database interface module adapted to retrieve videos and video information from the video database. The video database interface module functions to pre-fetch information from the video database based on anticipated user information needs. The video database interface module pre-fetches video information to allow the user to interactively and continuously browse large sets of videos using the carousel display without the user having to explicitly request and wait for new video information to be retrieved from the video database. The video database interface module also pre-fetches video information regarding videos that are related to a video the user has selected to view. The video database interface module further pre-fetches user account information such as playlists the user has created or videos that have been sent to the user. By pre-fetching information based on anticipated user needs, the video database client application compensates for slow retrieval of information through a wireless network minimizing time delays in providing video information to users.

### BRIEF DESCRIPTION OF THE DRAWINGS

FIG. 1 is an illustration of a conventional video database interface for designed for a mobile device.

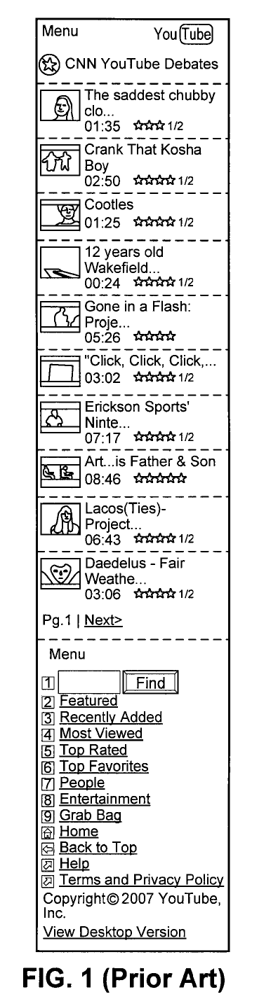

FIG. 2 is an illustration of the top level software and system architecture of a wireless communication device in one embodiment of the present invention.

FIG. 3 shows a video database home page 200 according to one embodiment of the video database client application 102.

FIG. 4 shows a video database home page 200 according to one embodiment of the video database client application 102.

FIG. 5 shows a video database home page 200 according to one embodiment of the video database client application 102.

FIG. 6 shows a most-viewed page 500 according to one embodiment of the video database client application 102.

FIG. 7 shows a user account page 600 according to one embodiment of the video database client application 102.

FIG. 8 shows a user account page 600 according to one embodiment of the video database client application 102.

FIG. 9 shows a user account page 600 according to one embodiment of the video database client application 102.

FIG. 10 shows a video viewing page 1000 according to one embodiment of the video database client application 102.

FIG. 11 shows a video viewing page 1000 according to one embodiment of the video database client application 102.

FIG. 12 illustrates a high-level block diagram of a wireless communication environment adapted to execute the video database client application 102 according to one embodiment.

### DETAILED DESCRIPTION

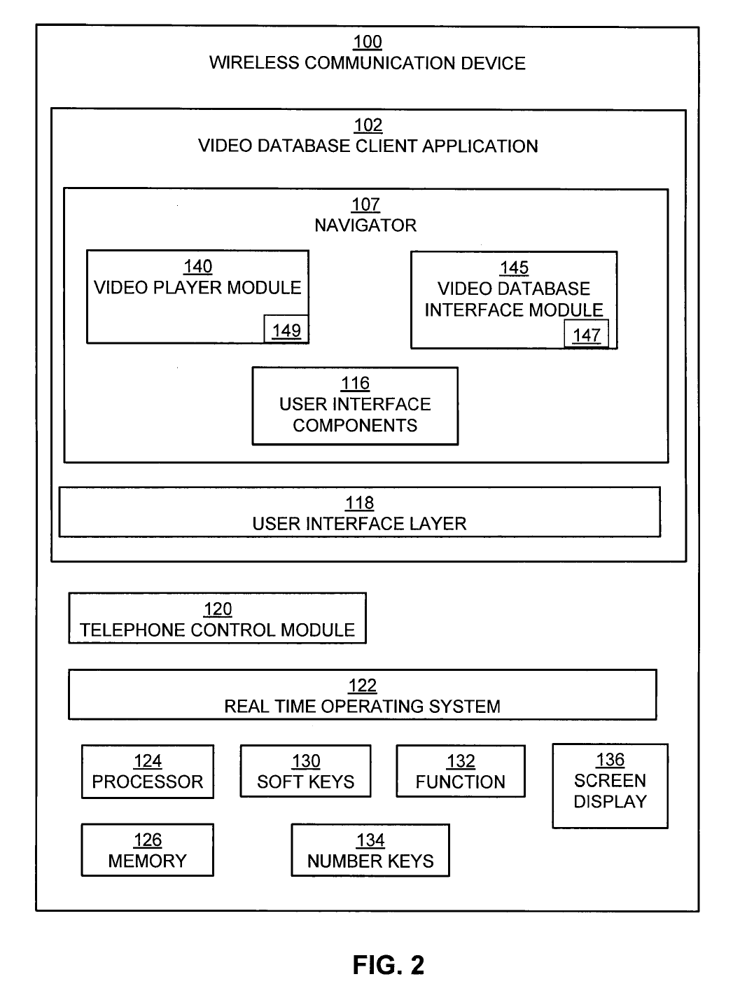

Referring now to FIG. 2, there is shown an illustration of the system and software architecture of a wireless communication device 100 configured to execute a video database client application 102 in accordance with an embodiment of the present invention. The hardware of the wireless communication device 100 includes a processor 124, memory 126, screen display 136, and keypad 128. Memory 126 includes ROM, RAM, and a flash memory for long term storage of data. A suitable wireless communication device 100 for providing the hardware features is a Nokia N series phone manufactured by Nokia Telecommunications, Inc.

The wireless communication device 100 stores in the memory 126 and executes a conventional real time operating system 122, which includes modules for managing power, memory, threads (communication connections), keypad inputs, and timer activities. The real time operating system 122 provides a standard application programming interface allowing higher level components of a video database client application 102 to request functionality of the wireless communication device 100, and to send and receive data.

Also stored in the memory 126 and in communication with the real time operating system 122 is telephony control module 120 that provides the primary telephone controls, including making and receiving telephone calls, managing multiple telephone lines (if appropriate), management of text messaging (if appropriate), monitoring of telephone signals, and other basic telephony functions. The telephony control module 120 includes a conventional telephone protocol stack that implements an air-interface protocol. The telephony control module 120 and the real time operating system 122 are typically provided by the manufacturer of the wireless communication device 100, and their particular implementation is not material here.

The screen display 136 is a bitmapped LCD or similar display device. The screen display 136 is typically of very limited resolution, for example about 90×60 to 240×320 pixels (at about .28 mm dot pitch) as would be appropriate for a compact, portable, hand-held electronic device. It is anticipated that advances in display technology will result in screen displays 136 of significantly higher resolution, but even so, the ergonomic and form factor requirements of wireless communication devices will result in screen displays that are relatively small (e.g., between 25×25 mm and 80×120 mm) as compared to the screen displays of notebook and desktop computers, and as a result will not display content designed for such larger screen displays in the exactly the same manner. The present invention is adapted to increase the ease of use of such screen displays when displaying video database content. In some embodiments, the screen display 136 is a touch screen. Touch screens are screen displays 136 which are sensitive to human touch and allow the user to enter inputs by touching the screen, either with a finger or a pointing device.

The wireless communication device 100 has a keypad 128 that includes a number of fixed function keys 132 for accessing defined functions of the wireless communication device 100 (e.g., “Send,” “End,” and “Power”), number keys 134 for entering digits (and if suitably encoded, for entering other characters), and programmable soft keys 130. Soft keys 130 are buttons that have variable functionality that changes depending on the particular screen display of the video database client application 102 being shown.

The wireless communication device 100 stores in its memory 126 and executes an instance of a video database client application 102 made in accordance with the present invention. This video database client application 102 includes: a navigator 107, a set of user interface components 116, a video player module 140, a video database interface module 145 and a user interface layer 118. The navigator 107 provides the primary user interface mechanism to the user, allowing access to user interface components 116 and through them to features of the application. The user interface components 116 provide a set of graphics primitives, file store functions, data elements and localization features that allow the application 102 to be used on a variety of wireless communication devices 100. The user interface layer 118 provides an interface for the navigator 107 and user interface components 116 to the real time operating system 122 and the telephone control module 120.

The video database client application 102 executes as a multi-threaded application, and is generally designed to run on any real time operating system 122, telephone control module 120, and wireless communication device 100 that provides sufficient ROM, RAM, and flash memory, a screen display 136, and basic services.

The navigator 107 provides the basic user interface of the video database client application 102 and displays user interface components 116 used to access and browse the video database 147 on the screen display 136 of the wireless communication device 100. The video content displayed by the navigator 107 is retrieved by the video database interface module 145 from a video database 147.

The navigator 107 includes a video player module 140 which integrates and controls a native video player 149 within the navigator 107. A native video player 149 is a software application which plays videos and that is native to the wireless communication device 100. The native video player 149 is usually associated with the real time operating system 122 of the wireless communication device 100. According to the type of wireless communication device 100, different native video players 149 specific to the wireless communication device 100 may be provided. Example native video players 149 include: RealPlayer®, Windows Media Player and QuickTime Video Player.

The video player module 140 identifies the native video player 149 of the wireless communication device 100. The video player module 140 interacts with user interface components 116 to control the display and interaction with the native video player 149 within the navigator 107. The video player module 140 further transmits information obtained from the user interaction with the native video player 149 to the video database interface module 145. The video database interface module 145 stores user interaction information in the video database 147.

The navigator 107 further includes a video database interface module 145. The video database interface module 145 provides an interface between the navigator 107 and a video database 147. The video database interface module 145 retrieves videos and video information from the video database 147 responsive to user selection of user interface components 116. The video database interface module 145 also retrieves videos and video information from the video database based on anticipated user information needs. The video database interface module 145 pre-fetches packets of video information containing information for plurality of videos. In some embodiments, the video database interface module 145 communicates directly with the video database 147. In some embodiments, the video database interface module 145 is adapted to communicate with an application programming interface (API) for a video database 147.

The video database 147 stores videos and video information. The video database 147 can be any database of videos which resides on a server. The video database 147 stores videos in a format compatible with native video player 149. The video database 147 also includes information about the videos such as, for example, length, name and source of the videos. The video database 147 further includes annotations of the videos based on information such as: user ratings, genre or type of the videos, frequency at which the videos are viewed and other videos that are related to the videos. The video database 147 stores information specific to users of the video database 147 such as: videos selected by the users, videos sent to the users, videos watched by the users, ratings submitted by the users, user subscriptions to video playlists or video providers, demographic information regarding the users and selected preferences of type of genre of videos selected by the users.

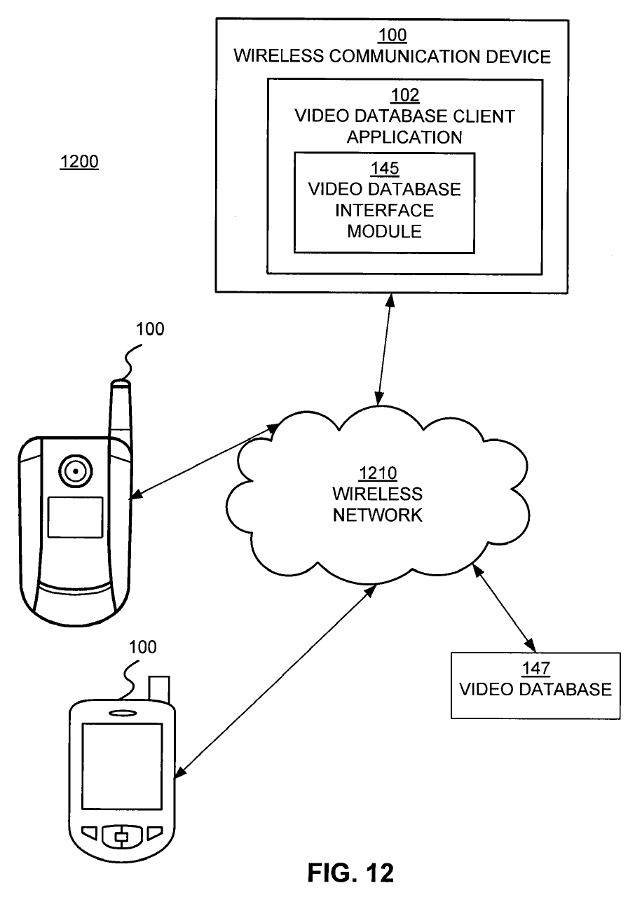

FIG. 12 illustrates a high-level block diagram of a wireless communication environment 1200 adapted to execute the video client application 102 according to one embodiment. One or more wireless communication devices 100 execute the video database client application 102. Upon execution of the video database client application 102, the video database interface module 145 sends and retrieves videos and video information from the video database 147 over a wireless telecommunications network 1210.

The wireless telecommunications network 1210 may be any type of wireless network such as a wireless local area network. In a specific embodiment, the wireless telecommunications network 1210 is a mobile device network such as a Global System for Mobile Communications (GSM) network. In one embodiment, the wireless telecommunications network 1210 uses standard communications technologies and/or protocols. The videos and video information exchanged over the wireless telecommunications network 1210 can be represented using technologies and/or formats including the hypertext markup language (HTML), the extensible markup language (XML), etc. In addition, all or some of videos and video information can be encrypted using conventional encryption technologies. In another embodiment, the entities can use custom and/or dedicated wireless communications technologies instead of, or in addition to, the ones described above.

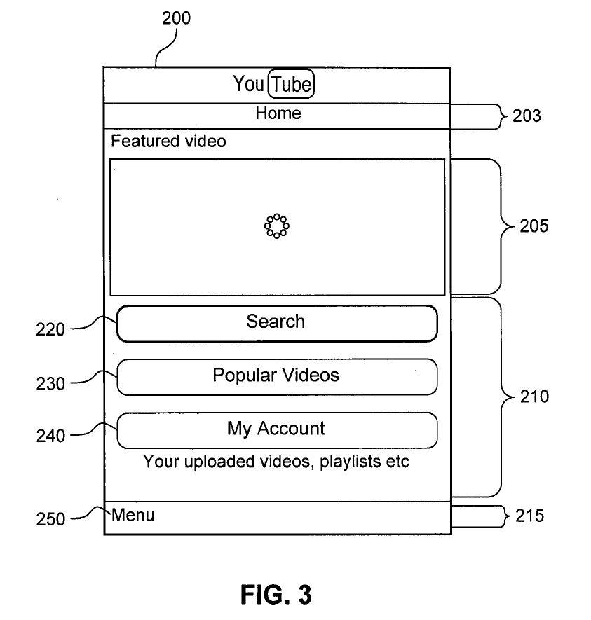

Following the terminology of the World Wide Web, an individual user interface screen of the video database client application 102 is herein called a “page.” Referring now to FIG. 3, there is shown a basic layout of a video database home page 200 displayed on the screen display 136 by the navigator 107. Each video database home page 200 generally has four basic areas: a navigation bar 203, a video display area 205, a button area 210 and a soft key area 215. The navigation bar 203, in one embodiment, remains present and displays the name associated with a particular page of the video database client application 102. Accordingly, in the video database home page 200 the navigation bar 203 indicates that the screen displayed is the “Home” page.

A video information display area 205 either displays video related information or an indicator that the video information is loading or being retrieved from the video database 147 by the video database interface module 145.

The video database home page 200 contains a button area 210 for receiving user input. Using the keypad 128 on the telephone, the user can scroll to select the one or more buttons in the button area 210 to navigate to different screens or be presented with other menu options or select the video that is displayed in the video information display area for viewing. If the wireless communication device 100 has a touch screen, the user can select buttons within the button area by touching the buttons. In one embodiment, in order for the button area 210 to have a minimal number of buttons (e.g. 3, 4 or 5 buttons) that take up a maximum amount of space in the button 210 area and to facilitate easy reading of the menu options and selection of the buttons, the buttons take up a majority (e.g., up to approximately 90-95%) of the width of the screen 136. Other embodiments have more or fewer buttons of varying sizes.

In the embodiment illustrated, the button area 210 contains a search button 220, a popular videos button 230 and a user account button 240, each button labeled according to its title. The search button 220 enables the user to enter textual search queries to search the video database 147. Upon selection of the search button 220, the user is presented with a text entry screen that can be used to enter search queries. In a specific embodiment, the text entry screen is a pop-up screen which comprises a majority (up to approximately 90-95%) of the screen display.

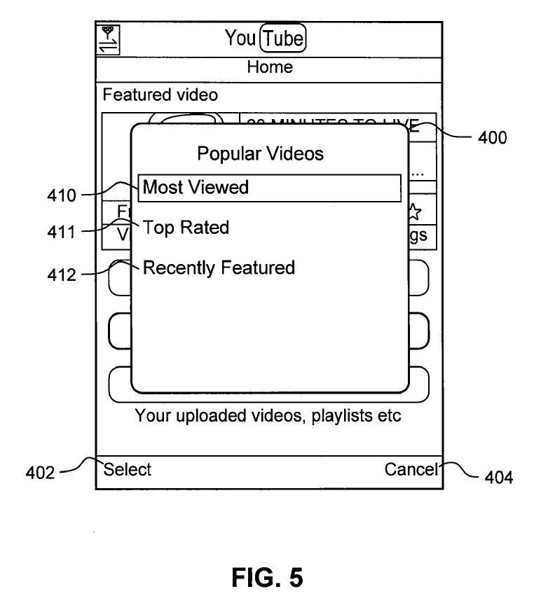

The popular videos button 230 enables the user to view information for videos in the video database 147 that are frequently accessed or highly rated. Upon selection of the popular videos button 230, the user may either be presented with a set of popular videos retrieved from the video database 147 or presented with a subsequent screen to further select a criterion of popularity. This screen is discussed in detail below with respect to FIG. 5.

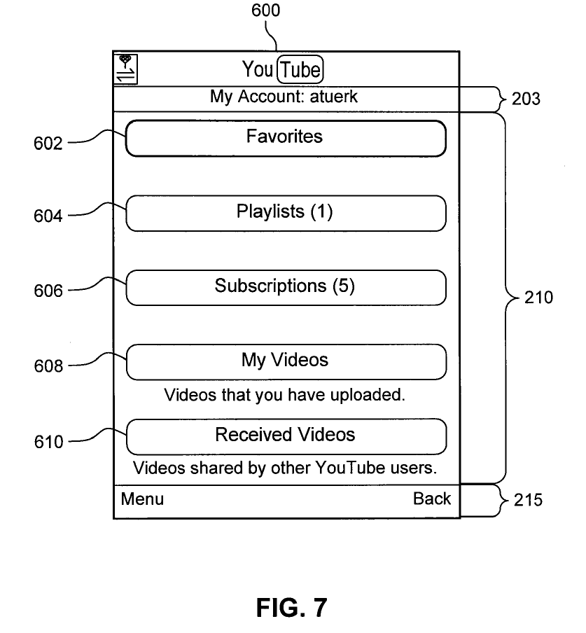

The “my account” button 240 allows the user to access information stored in association with the user's account in the video database 147. Upon selecting the user account button 240, the user can login to their account. If the user has previously selected to automatically login, upon selecting the user account button 240 the user will be presented with an account screen that lists menu options specific to the user's account settings. This screen is discussed in detail below with respect to FIG. 7.

The soft key area 215 displays menu options and functions that can be selected using soft keys 130. The menu options and functions associated with the soft keys 130 are dependant on the page or screen of the video database client application 102. In the video database home page 200, a menu key 250 can be selected to display a menu of options that the user may navigate and make selections from using the up and down keys. In a specific embodiment, the menu of options is a pop up menu listing a set of options including the ability to search the database, navigate to other pages in the video database client application 102, view related videos to the video for which video information is currently displayed, upload videos or flag videos for inappropriate content.

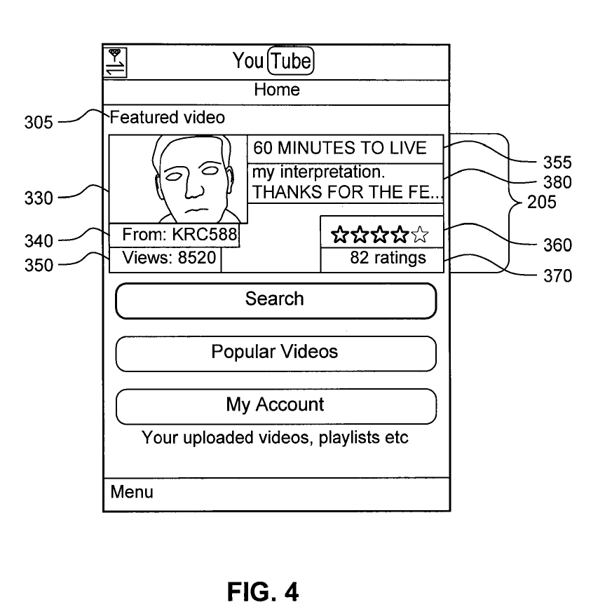

FIG. 4 shows a video database home page 200 according to one embodiment. In the embodiment illustrated, the video information display area 205 displays video information from the video database 147.

The video information display area 205 displays video information for a featured video 305 in the video database 147. In alternate embodiments, the video information display area 205 of the video database home page 200 can display information for videos selected based on the user's account settings. For example, the video information display area 205 can display information for videos recommended for the user or video information for unwatched videos sent to the user's account.

The video information display area 205 displays video information retrieved by the video database interface module 145 from the video database 147. Typical information displayed in the video information display area 205 includes images from the video, the title of the video, ratings for the video, length of the video, genre of the video, the source of the video and the popularity/ratings of the video. In the embodiment illustrated in FIG. 3, the video information display area 205 displays information including the “source” or user who submit the video 340, the number of views of the video 350, an image or frame of the video 330, an overall rating for the video 360, the number of ratings used to determine the overall rating 370, the title of the video 355 and comments or text describing the video 380.

FIG. 5 shows a screen of a video database home page 200 in which the popular videos button 230 has been selected according to one embodiment. Upon selection of the popular windows button 230, a popular videos window 400 is displayed. In the embodiment illustrated, the popular videos window 400 is a pop-up window which is displayed overtop of the video database home page 200. In alternate embodiments, the popular videos window 400 may be presented as a separate page on screen 136. The popular videos window 400 contains additional buttons which list different selection criteria for popular videos. The soft keys 130 in the soft key area 215 allow the user to select 402 an option or cancel 404 the popular videos window 400 to return to the video database home page 200. Selection criteria for popular videos may include the number of views of a video, the rating of a video or videos which have been pre-selected by the video database 147 administrators such as featured videos. In the embodiment illustrated in FIG. 4, the popular videos window 400 includes a most viewed button 410, a top rated button 411 and a recently featured button 412. When selected, the most viewed button 410 directs the user to a most viewed page 500 which displays the most frequently viewed videos. Accordingly, when the top rated button 411 is selected, the user is directed to a top rated page which displays the videos with the top overall user ratings. The recently featured button 412 directs the user to videos recently selected as feature videos by the video database 147 administrator. In some embodiments, the featured videos are automatically selected by the video database client application 102.

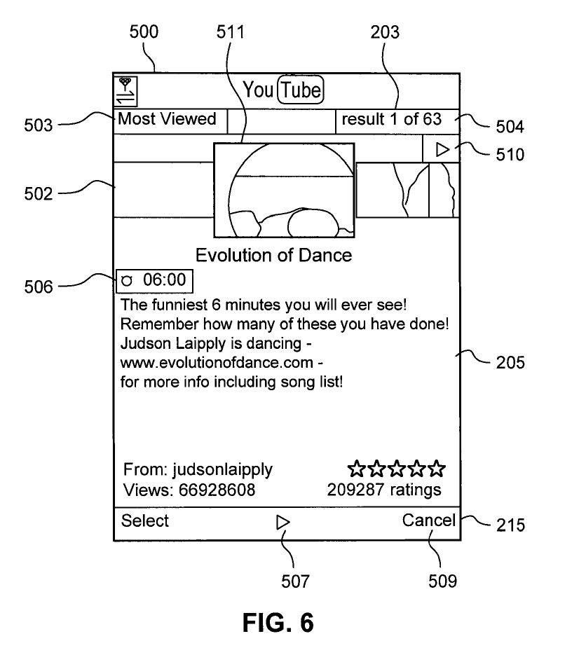

FIG. 6 shows a most viewed page 500 of the video database client application 102 according to one embodiment. The most viewed page 500 displays the videos in the video database that are most frequently viewed by the users of the video database. The most viewed page 500 includes a video information display area 205, a navigation bar 203, a soft key area 215 and a carousel display 502. The navigation bar 203 displays an indicator 503 that the page is the most viewed page 500.

The most viewed page 500 is representative of a page that the video database client application 102 uses to interactively display any set of videos such as: a set of featured videos, a set of top rated videos, a set of recently featured videos, a set of favorite videos or a set of videos retrieved responsive to a search query. In the most viewed page 500, the carousel display 502 displays a set of images representing a subset of the most viewed videos. In one embodiment, a maximum of 5 images is shown at once. In one embodiment, these images are thumbnails from the videos. In other embodiments, they are small versions of the videos themselves. In the center of the carousel display 502, a selected image 511 is enlarged relative to the other images in the carousel display 502. In one embodiment, the selected image is at least 1.5 times larger than the other images displayed in the carousel display 502.

Information for the video associated with the selected image 511 is displayed in the video information display area 205. The video information display area 205 can include any information for the video associated with the selected image 511. In the embodiment illustrated, the video information display area 205 includes the length 506 of the video associated with the selected image 511 in minutes and seconds. The navigation bar 203 additionally shows an indicator 504 which displays the a number of videos associated with the selected image 511 relative to the number of videos contained in the set of most popular videos. In the embodiment illustrated, the video is indicated as being the first video in a set of 63 most popular videos.

The carousel display 502 includes a control key 510 which allows the user to navigate through the entire set of popular videos and select images for which to display video information. Responsive to selection of the control key 510, the images in the carousel display 502 are shifted to the left and the rightmost image is replaced with a new image. When the images are shifted, the image to the right of the selected image 511 becomes the selected image 511 and is enlarged. Information for the video associated with the newly selected image 511 is displayed in the video information display area 205. When the user has scrolled past a number of images greater than the number of images in the carousel display (e.g. 5), the carousel display 502 includes a control key which allows the user to shift the images to the right and select the image left of the selected image 511. To continue to view images and information for all of the videos in the set of most popular videos, the user can continue to press the control keys to scroll through the video information.

The video database interface module 145 is adapted to interface with the control key 510 in order to retrieve video information and images from the video database 147. Responsive to selection of the control keys 510, the video database interface module 145 pre-fetches packets of images and video information for a plurality of the most popular videos. Pre-fetching images and information in packets allows the user to scroll through the most popular videos without having to wait for video information and images to be retrieved over the wireless network. The number of videos for which information and images are pre-fetched in each packet is adjustable either automatically or via a preference setting in the client application or at the server to accommodate the speed at which the information can be retrieved without causing delays. In some embodiments, packets include information and images from 5-10 videos. Providing pre-fetched video information on a carousel display 502 obviates the need for a user to load and scroll through a series of images in a time-consuming manner.

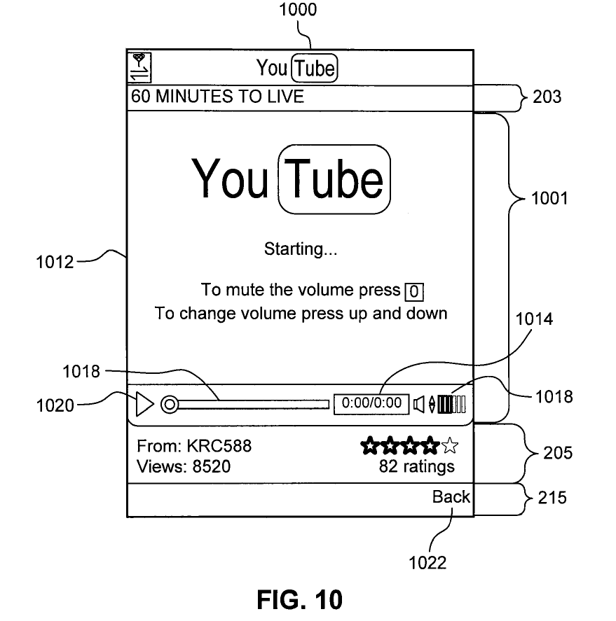

The soft key area 215 of the most viewed page 500 includes a home key 509 the user may select to navigate to the video database home page 200. The soft key area 215 of the most viewed page 500 further includes a play key 507 which the user may select to watch the video associated with the selected image 511. Upon selection of the play key 507, the user is redirected to a video viewing page 1001 (FIG. 10) to watch the video associated with the selected image 511.

FIG. 7 shows a user account page 600 according to one embodiment of the video database client application 102. The user account page 600 presents the user with a set of options based on information from user interactions with the video database 147. User interactions with the video database 147 may include user selection of account settings that define personal information and preferences for the user, videos the user has viewed, videos the user has rated, videos the user has uploaded, videos the user has received, and video playlists and subscriptions the user has specified. In one embodiment, the user can customize the available features displayed on the user account page.

The user account page 600 includes a navigation bar 203, a button display area 210 and a soft key area 215. The navigation bar 203 of the user account page displays the account name of the user that is currently logged in.

In the embodiment shown, the user account page 600 contains a button display area 210 which comprises the majority (up to approximately 90-95%) of the screen. The button display area 210 contains 5 buttons that provide the user with options based on the user's interactions with the database. The button display area 210 includes a favorites button 602, a playlists button 604, a subscriptions button 606, a my videos button 608, and a received videos button 610. The video database interface module 145 retrieves and lists information from the user's account from the video database 147 within the buttons.

Responsive to selection of the favorites button 602, the user is presented with a set of videos that the user has either specified as favorites and/or a set of videos that are frequently viewed by the user. The user can specify account settings (e.g. favorite videos, playlists, subscriptions) by accessing their account in the video database 147 using the video database client application 102 on a wireless communications device 100. In one embodiment, the user can also access their account in the video database 147 using an internet browser on a personal computer. In a specific embodiment, the set of favorite videos is displayed using a carousel display 502 in an interface similar to that of the most viewed page 500.

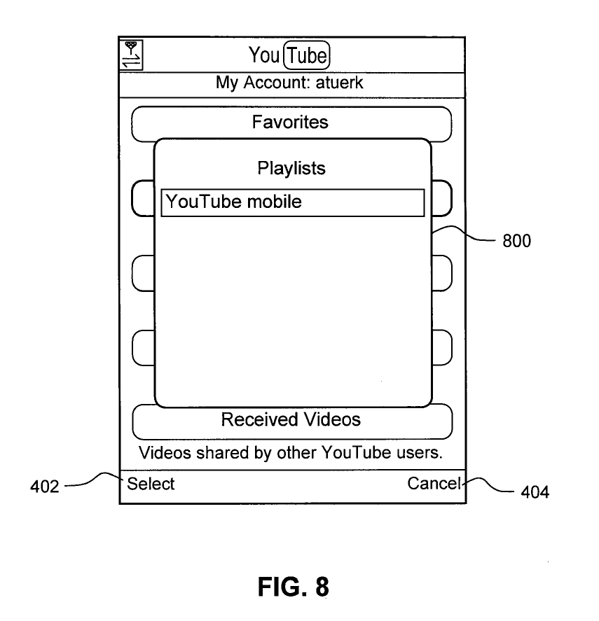

The video database interface module 145 retrieves the number of playlists the user has created or added to their account and lists this number within the playlists button 604. A playlist is a set of videos the user has designated to be played together in a specified order. Upon selection of the playlists button 604, the user is presented with a selection of playlists they have created or added to their account. In a specific embodiment, the user is presented with the playlists window 800 illustrated in FIG. 8. In the embodiment illustrated, the playlists window 800 is a pop-up window, which is displayed as an overlay on top of the user account page 600. In alternate embodiments, the playlists window 800 may be presented as a separate page on screen 136. The user may use the up and down keys to scroll in conjunction with the select key 402 in the soft keys area 215 to select a playlist from the playlist window 800.

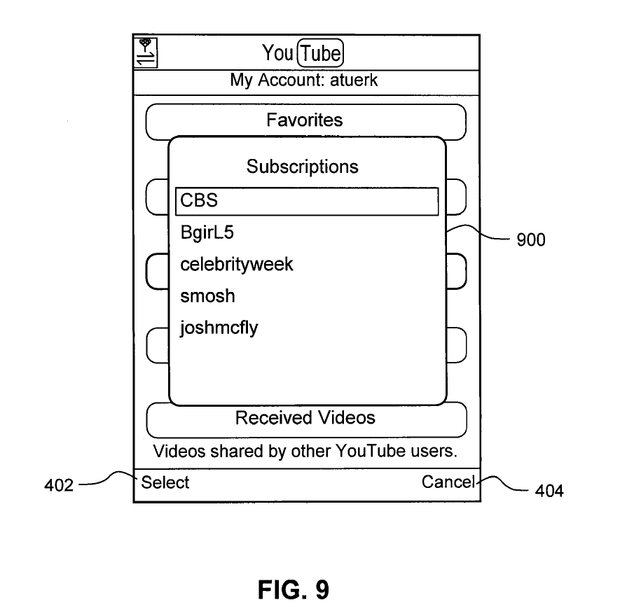

The video database interface module 145 retrieves and lists the number of subscriptions the user has created within their account within the subscriptions button 606. Upon selection of the subscriptions button 606, the user is presented with a selection of their subscriptions. In a specific embodiment, the user is presented with subscriptions popup window 900 illustrated in FIG. 9. The user can then use the up and down keys or touch screen in conjunction with the select key 402 in the soft keys area 215 to select a subscription from the subscriptions window 900.

Responsive to selection of the my videos button 602, the user is presented with a set of videos that the user has uploaded to the video database 147. In some embodiments, the video database client application 102 scans the memory of the wireless communication device 100 for videos and presents this set of videos to the user for uploading to the video database 147. According to the embodiment, this scan may be specifically requested by the user through the use of a menu option or may be automatically performed responsive to the user accessing the video database client application 102. In a specific embodiment, the set of videos the user has uploaded is displayed using a carousel display 502 in the interface discussed above in reference to the most viewed page 500.

Responsive to selection of the favorites button 602, the user is presented with a set of videos that the user has either specified as favorites and/or a set of videos that are frequently viewed by the user. In a specific embodiment, the set of favorite videos is displayed using a carousel display 502 in the interface discussed above in reference to the most viewed page 500.

FIG. 10 depicts a screen shot of a video viewing page 1000 of the video database client application 102 according to one embodiment. The video viewing page 1000 includes a navigation bar 203, a video player area 1001, a video information display area 205 and a soft key area 215.

The navigation bar 203 displays the name of the video currently viewed in the video viewing page 1000. The video player area 1001 includes a video viewing area 1012 and user interface components 116 for controlling the native video player 149. The video player module 140 integrates the native video player 149 in the video viewing area 1012. The video player module 140 interacts with the native video player 149 and the user interface components 116 in order to control the native video player 149.

Different user interface components 116 for controlling the native video player 149 may be included in the video viewing page 1000. In the embodiment illustrated, the video viewing page 1000 includes a play button 1020 used to play or pause the video. The video viewing page 1000 further includes a graphic control element including a slider used to display and select the time point of the video currently viewed 1018. The video viewing page 1000 further includes a time display element 1014 which displays the time point of the video currently viewed as well as the length of the video in minutes and seconds. The video viewing page 1000 further includes a sound control element 1018 that displays the volume of the video being viewed.

The video information display area 205 displays information regarding the video being viewed. In the embodiment illustrated, the video information display area 205 includes a composite rating of the video, the number of ratings used to determine the composite rating, the source of the video and the number of times the video has been viewed. The soft key area 215 includes a back button 1022 which redirects the user to the page from which the video has been selected.

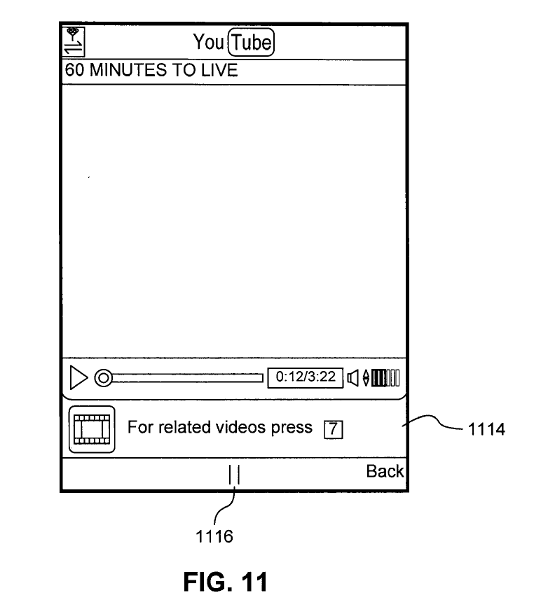

FIG. 11 depicts a screen shot of a video viewing page 1000 of the video database client application 102 according to one embodiment. In this embodiment, the video information display area 205 is used to display a menu option to view videos that are related to the video currently viewed in the video viewing page 1000. Responsive to selection of a control to view the video in the video viewing page, the video database interface module 145 pre-fetches a set of video information for videos that are related to the video being viewed in the video viewing page 1000 from the video database 149. Videos that are related to the video being viewed may be selected based on criteria such as the source of the video, the genre of the video, the title of the video and any other type of annotation associated with the video. In some embodiments, the user may specify one or more of the criteria for related videos in their account. Upon selection of the menu option to display the set of related videos, the user is presented with the retrieved video information. In one embodiment, the retrieved video information is presented in a interface including a carousel display 502 similar to the interface described in reference to the most viewed page 500.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed:

1. A method for displaying video content on a wireless communication device, the method comprising:
retrieving, by a client application executed on the wireless communication device, video information from a video server over a network, the video information describing video content available from the video server;
displaying the retrieved video information in a first portion of a display device of the wireless communication device, the first portion having a displayed width of substantially the entire display; and
displaying user interface controls in a second portion of the display device, at least one of the displayed user interface controls having a displayed width of substantially the entire display.

2. The method of claim 1, wherein the first portion and the second portion occupy a majority of the display screen.

3. The method of claim 2, wherein the first portion is above the second portion.

4. The method of claim 2, wherein the user interface controls include a control for entering a search query to be executed on the video server.

5. A video database application comprising:
a video information display area comprising an image associated with a video and information for the video; and
a button area adjacent to the video information display area comprising a plurality of buttons, wherein each button navigates to a different screen of the video database application and at least a first button navigates to a screen which allows a user to enter a search query to the video database.
